(19) United States
(12) Patent Application Publication
(10) Pub. No.: US 2009/0187857 A1
(43) Pub. Date: Jul. 23, 2009

(54) MOBILE TERMINAL DEVICE

(75) Inventor: Hiroyuki TANAKA, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/235,021

(22) Filed: Sep. 22, 2008

(30) Foreign Application Priority Data
Jan. 22, 2008 (JP) P2008-11322

(51) Int. Cl. G06F 3/048

(52) U.S. Cl. 715/811

(57) ABSTRACT

When starting a small thumbnail display mode, predetermined data prioritized by a priority setting unit are sequentially output from a data storage unit to a decoder and a display processing unit to preliminarily generate large thumbnail image data. The generated large thumbnail image data are temporarily stored in a thumbnail image data storage unit so as to be efficiently displayed in the priority order after switching of the display node to the large thumbnail display mode.

### BACKGROUND OF THE INVENTION

1. Field of the Invention

The present invention relates to a mobile terminal device, and more particularly, to a mobile terminal device having a function for displaying a thumbnail image.

2. Related Art

A mobile terminal device such as a cellular phone has a thumbnail display function for improving visibilities of various types of data including recorded image data. The thumbnail display function serves to display thumbnail image data which have been contracted in the form of icons of predetermined data indicating outline of the data for the purpose of improving the viewing speed by displaying plural data at a time.

An image pickup device which allows the user to easily select the desired data by means of the above-described thumbnail display function is disclosed in Japanese Unexamined Patent Application Publication No. 2007-266661 (Patent Publication 1). The image pickup device displays a text with the thumbnail image mainly related to a video image to allow the user to easily select the desired data.

The thumbnail display function may be put into use for switching between a thumbnail image displayed as a fine thumbnail image (large thumbnail image) and a thumbnail image which allows more thumbnail images each with inferior quality (small thumbnail image) to be displayed.

The user is allowed to select the desired data while switching the display between the large thumbnail image and the small thumbnail image for improving the user's usability. The aforementioned mobile terminal device with the large/small thumbnail display function may fail to sufficiently improve the usability owing to the low speed for displaying the switched thumbnail image.

The Patent Publication 1 does not disclose the technology for efficiently selecting the desired data by switching the image display among the plural thumbnail images.

### SUMMARY OF THE INVENTION

The present invention was conceived in consideration of the circumstances encountered in the prior art such as mentioned above, and accordingly, an object of the present invention is to provide a mobile terminal device capable of switching an image display among the plural thumbnail images efficiently, and to improve usability of the thumbnail display function and efficiency for the user to select the image upon selection of the desired data from the thumbnail images.

The above and other objects can be achieved according to the present invention by providing, in one aspect, a mobile terminal device comprising:

a data storage unit configured to store data;

a first generation unit configured to generate a first thumbnail image data based on the data output from the data storage unit;

a first display unit configured to display a plurality of first thumbnail images corresponding to a plurality of the first thumbnail image data generated by the first generation unit;

a cursor moving unit configured to move a cursor which selects one of a plurality of the first thumbnail images displayed by the first display unit;

a priority setting unit configured to set a priority with respect to the data stored in the data storage unit in accordance with the first thumbnail image selected by the cursor moved by the cursor moving unit;

a second generation unit configured to generate second thumbnail image data each having a different size from that of the first thumbnail image data based on the data having the priority set by the priority setting unit;

a second thumbnail image data storage unit configured to store the plurality of the second thumbnail image data generated by the second generation unit;

a receiver unit configured to receive a command to display the second thumbnail image corresponding to the second thumbnail image data; and

a second display unit configured to display the plurality of the second thumbnail images stored in the second thumbnail image data storage unit sequentially in a predetermined array from the second thumbnail image corresponding to the second thumbnail image data formed from the data in an order of the priority upon reception of a command to display the second thumbnail images by the receiver unit.

In another aspect of the present invention, there is also provided a mobile terminal device comprising:

a display mode switching unit configured to switch from a first thumbnail display mode for displaying a plurality of first thumbnail images each with a predetermined size to a second thumbnail display mode for displaying a plurality of second thumbnail images each having a size larger than that of the first thumbnail images when starting of the first thumbnail display mode;

a data storage unit configured to store data;

a first generation unit configured to generate the first thumbnail image data based on the data output from the data storage unit when starting the first thumbnail display mode;

a first display unit configured to display the first thumbnail image corresponding to the plurality of the first thumbnail image data generated by the first generation unit;

a cursor moving unit configured to move a cursor to select one of the plurality of the first thumbnail images displayed by the first display unit;

a priority setting unit configured to set a priority with respect to the data stored in the data storage unit in accordance with the first thumbnail image selected by the cursor moved by the cursor moving unit;

a second generation unit configured to generate the second thumbnail image data of the second thumbnail image to be displayed when the second thumbnail display mode is started by the display mode switching unit based on the data having the priority set by the priority setting unit;

a second thumbnail image data storage unit configured to store the second thumbnail image data generated by the second generation unit; and

a second display unit configured to display the second thumbnail images corresponding to the plurality of the second thumbnail image data stored in the second thumbnail image data storage unit sequentially in a predetermined array from the second thumbnail image corresponding to the second thumbnail image data formed from the data in an order of the priority thereof after starting the second thumbnail display mode by the display mode switching unit.

In a further aspect of the present invention, there is also provided a mobile terminal device comprising:

a data storage unit configured to store a plurality of data;

a display unit configured to display an image corresponding to the data stored in the data storage unit;

a first operation unit configured to receive a switching operation between a first thumbnail display mode and a second thumbnail display mode, the first thumbnail display mode being for generating first thumbnail image data based on a plurality of the data stored in the data storage unit to display images corresponding to the plurality of the first thumbnail image data in a predetermined order, and the second thumbnail display mode being for displaying images corresponding to the second thumbnail image data each having a display size larger than that of the first thumbnail image data;

a second operation unit configured to select one of displayed images corresponding to the plurality of the first thumbnail image data when the first thumbnail display mode is set;

a generation unit configured to generate the second thumbnail image data based on selection data correlated with the first thumbnail image selected by the second operation unit from those corresponding to the plurality of the first thumbnail image data, and data correlated with predetermined numbers of images arrayed in an order adjacent to the selected first thumbnail image in the predetermined order when the first thumbnail display mode is set; and

a control unit configured to display the second thumbnail image data generated by the generation unit sequentially from the selected data on the display unit when receiving a switching operation from the currently activated first thumbnail display mode to the second thumbnail image data through the first operation unit.

The mobile terminal device according to the present invention efficiently switches the image among plural thumbnail images upon selection of the desired data from the thumbnail images to improve usability of the thumbnail display function and further to allow the user to select the image efficiently upon selection of the desired data from the thumbnail images.

The nature and further characteristic features of the present invention will be made clearer from the following descriptions made with reference to the accompanying drawings.

### BRIEF DESCRIPTION OF THE DRAWINGS

In the accompanying drawings:

FIG. 1 shows an outer appearance of a cellular phone according to the present invention;

FIG. 2 shows an outer appearance of another cellular phone according to the present invention;

FIG. 3 is a block diagram showing an inner structure of the cellular phone according to the present invention;

FIG. 4 shows an exemplary thumbnail image displayed on a main display, in which FIG. 4A shows an exemplary display of a small thumbnail image and FIG. 4B shows an exemplary display of a large thumbnail image;

FIG. 5 is a functional block diagram with respect to a function for generating thumbnail image data;

FIG. 6A is a conceptual view showing various data and attribute information database stored in a data storage unit;

FIG. 6B is a view partially showing a data list having image pickup data arrayed in accordance with an image pickup date;

FIG. 7 shows a first example of a thumbnail display mode switching process, wherein FIG. 7A shows a small thumbnail display mode, and FIG. 7B shows a large thumbnail display mode;

FIG. 8 shows a second example of a thumbnail display mode switching process, in which FIG. 8A shows a small thumbnail display mode and FIG. 8B shows a large thumbnail display mode;

FIG. 9 is a flowchart of the thumbnail display mode switching process as a third example, which is performed in a cellular phone according to the embodiment of the present invention;

FIG. 10 shows a part of the data list having the image pickup data stored in the data storage unit arrayed in accordance with the image pickup date;

FIG. 11 shows the third example of a thumbnail display mode switching process, in which FIG. 11A shows a small thumbnail display mode and FIG. 11B shows a large thumbnail display mode;

FIG. 12 shows a part of an exemplary data list stored in an attribute information database, in which FIG. 12A shows a part of the data list having data arrayed based on the order of the file size and FIG. 12B shows a part of data list having data arrayed based on the category;

FIG. 13 is a functional block diagram which especially shows the function for preliminarily generating the large thumbnail image data upon starting of the small thumbnail display mode; and

FIG. 14 is a flowchart of another thumbnail display mode switching process.

### DESCRIPTION OF THE PREFERRED EMBODIMENTS

An embodiment of a mobile terminal device according to the present invention will be described hereunder with reference to the accompanying drawings.

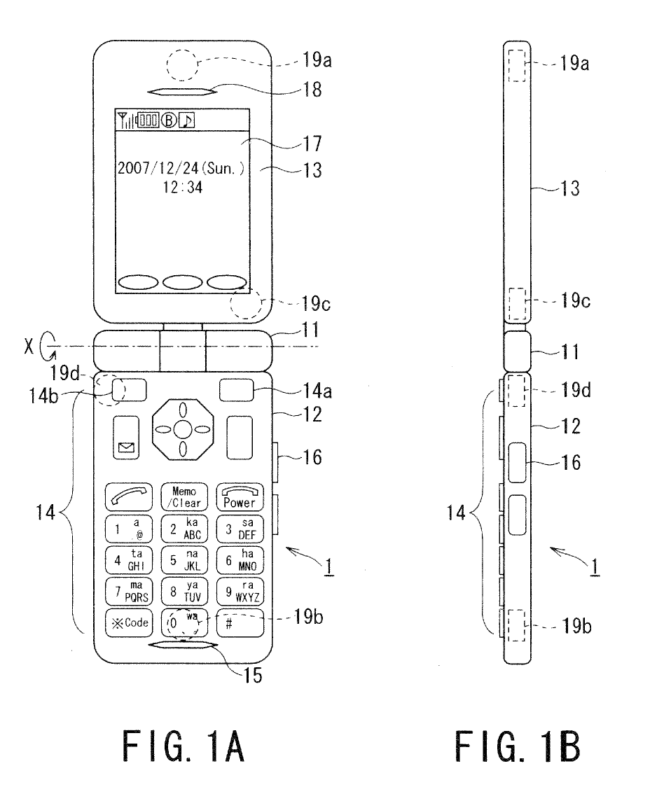

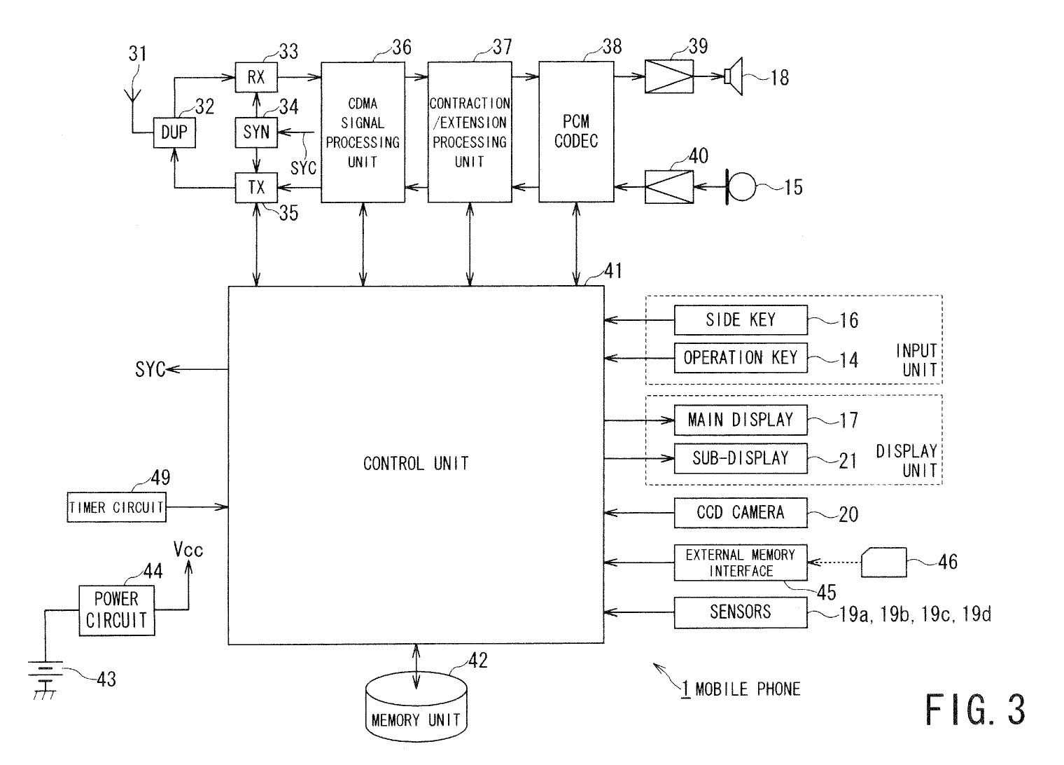

Referring to FIGS. 1A and 1B, the cellular phone 1 is formed by connecting a first package 12 and a second package 13 by means of hinge 11 so as to be foldable in an arrow direction X. An antenna for transmission/reception (antenna 31 shown in FIG. 3 to be described later) is disposed at a predetermined position inside the cellular phone 1. The first and second packages 12 and 13 of the cellular phone 1 has a shape of package or casing, called “package” hereinlater. Transmission/reception of electric wave is performed with respect to a base station (not shown) via the built-in antenna.

The first package 12 is provided, on its surface, with an operation key 14 including ten keys from “0” to “9”, a call key, a redial key, a call-ending/power key, a clear key, and a menu key, through which various commands may be input.

The first package 12 is provided with an arrow key and a return key as the operation key 14 at the upper portion. A user operates the arrow key in the vertical and lateral directions to move a cursor in the vertical and lateral directions correspondingly. In the present embodiment, the cursor is operated to move on the thumbnail image displayed on a main display 17. Various functions may be enabled by pressing the return key. In the embodiment, the user presses the return key when the predetermined thumbnail image is selected by the cursor so as to display the selected data of the predetermined thumbnail image independently.

The first package 12 is further provided with a first soft key 14a and a second soft key 14b above the arrow key and the return key. In the embodiment, the thumbnail image may be switched between the large image and the small image by depressing the first and the second soft keys 14a and 14b inward of the first package 12.

A side key 16 provided on the first package 12 for operating the cellular phone 1 is pressed inward of the first package 12 when the cellular phone 1 is in the open state and the closed state for allocating the corresponding processes, respectively.

The first package 12 includes a microphone 15 below the operation key 14 for collecting voice of a user who is talking with the phone.

The first package 12 has a battery pack (not shown) installed in the back side. When the call-ending/power key is turned ON, power is supplied from the battery pack to the respective circuits so as to be started.

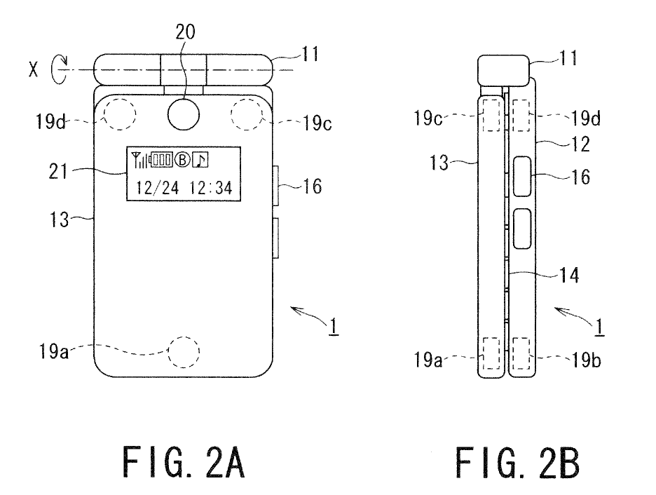

Meanwhile, the second package 13 has the main display 17 on the upper surface for displaying the electric wave reception state, the remaining battery level, contents of e-mails, simplified homepages, images picked up by a CCD (Charge Coupled Device) camera (as CCD camera 20 shown in FIG. 2 to be described later), contents received from the external contents server (not shown), contents stored in a memory card (as a memory card 46 shown in FIG. 3 to be described later) and the like. The main display 17 may be formed as an LCD (Liquid Crystal Display), an organic EL (Electro Luminescence) display, an inorganic EL display, and the like.

A receiver 18 is disposed at a predetermined position above the main display 17, which allows the user to talk over the phone. The cellular phone 1 is provided with a speaker (not shown) at a predetermined position as a voice output portion other than the receiver 18.

Magnetic sensors 19a, 19b, 19c and 19d for detecting open/closed state of the cellular phone 1 are disposed at predetermined positions inside the first package 12 and the second package 13, respectively.

FIG. 2 shows another outer appearance of the cellular phone 1 of folding type as an example of the cellular phone according to the present invention. The cellular phone 1 shown in FIG. 2 is closed while being turned in the arrow direction X from the open state as shown in FIG. 1 when the first package 12 and the second package 13 are substantially overlapped with each other. FIG. 2A is a front view of the cellular phone 1 in the closed state, and FIG. 2B is a side view of the cellular phone 1 in the closed state.

The CCD camera 20 is installed in the upper surface of the second package 13, which allows the user to pick up the image of the desired object. The cellular phone 1 in the embodiment has a function for categorizing the image pickup data picked up by the CCD camera 20 so as to be stored. Any category may be added by the user based on the scene of the picked up data including such title as travel, business, family, and landscape.

A sub-display 21 as a liquid crystal display is disposed below the CCD camera 20 for displaying an antenna pictograph indicating the current antenna sensitivity level, a battery pictograph indicating the battery remaining level of the cellular phone 1, and the present time.

FIG. 3 shows an inner structure of the cellular phone 1 according to the embodiment of the present invention.

After a wireless signal transmitted from a base station, not shown, is received by an antenna 31, it is input to a reception circuit 33 via an antenna shared unit (DUP) 32. The reception circuit (RX) 33 mixes the received wireless signal with a local oscillation signal output from a frequency synthesizer (SYN) 34 so as to be subjected to a frequency conversion into an intermediate frequency signal. The reception circuit 33 further subjects the down converted intermediate frequency signal to the orthogonal demodulation to output a reception baseband signal.

The reception baseband signal from the reception circuit 33 is input to a CDMA signal processing unit 36 which is provided with a not shown RAKE receiver unit. In the RAKE receiver unit, plural passes contained in the reception baseband signal are subjected to an inverse diffusion with the corresponding spread codes (identical to that of the spread reception signal). Each of the thus inverse-diffused pass signals has its phase adjusted, and further coherent Rake synthesized. The Rake synthesized data string is subjected to deinterleaving and channel decoding, and further subjected to a binary data determination. As a result, a reception packet data with a predetermined transmission format may be obtained. The reception packet data are input to a compression/extension processing unit 37.

The compression/extension processing unit 37 is formed as a DSP (Digital Signal Processor) which allows a multiple separation unit, not shown, to separate the reception packet data output from the CDMA signal processing unit 36 in accordance with media, and performs decoding with respect to the respective separated media.

For example, a digital video signal decoded through a video codec of the compression/extension processing unit 37 is input to a control unit 41. The control unit 41 displays the video image in response to the digital video signal output from the compression/extension processing unit 37 on a main display 17 via a video RAM (for example, VRAM), not shown. The control unit 41 is capable of displaying not only the received video image data but also those picked up by the CCD camera 20 on the main display 17 via the not shown video RAM.

The compression/extension processing unit 37 performs compression coding of the digital video signal output from the control unit 41, and multiplexes the video image data in the multiple separation unit in accordance with the predetermined transmission format so as to be formed into a packet. The resultant transmission packet data are output to the CDMA signal processing unit 36.

The CDMA signal processing unit 36 subjects the transmission packet data output from the compression/extension processing unit 37 to a spectrum diffusion process using a spread code allocated to the transmission channel, and outputs the spectrum diffusion processed output signal to a transmission circuit (TX) 35. The transmission circuit (TX) 35 modulates the spectrum diffused signal using a digital modulation process such as QPSK (Quadrature Phase Shift Keying). The transmission circuit 35 synthesizes the digitally modulated transmission signal with the local oscillation signal generated by the frequency synthesizer 34 so as to be frequency converted (up convert) into the wireless signal. The transmission circuit 35 subjects the up converted wireless signal to a high frequency amplification to establish the transmission power level commanded by the control unit 41. The high frequency amplified wireless signal is supplied to the antenna 31 via the antenna shared unit 32. The antenna 31 then transmits the signal to the base station, not shown.

The cellular phone 1 includes an external memory interface 45 with a slot through which the memory card 46 is detachably inserted. The memory card 46 as a type of the flash memory card, for example, NAND type flash memory card and NOR type flash memory card allows writing and reading of various data including images, voices and sounds via a 10-pin terminal.

The cellular phone 1 further includes a timer circuit 49 for measuring an accurate current time.

The control unit 41 is formed of a CPU, a ROM, and a RAM. The CPU executes various types of processing in accordance with the program stored in the ROM or various types of application programs loaded from a memory unit 42 to the RAM. The CPU also generates various control signals to be supplied to the respective elements for centrally controlling the cellular phone 1. The RAM stores the required data for the CPU to execute various types of processing.

The memory unit 42 is formed of a flash memory element as a non-volatile memory or an HDD (Hard Disc Drive) capable of electrically writing and deleting data for storing various application programs and data blocks executed by the CPU of the control unit 42. A power circuit 44 generates a predetermined operation power supply voltage Vcc based on an output of a battery 43 so as to be supplied to the respective circuits.

The cellular phone 1 includes a thumbnail display function for displaying plural data using thumbnail images upon selection of the desired data from the data stored in a data storage unit 70 (see FIG. 5) such as the memory unit 42 and the memory card 46 so that the desired data are selected. Unlike the process for selecting the desired data from a list of text information such as a data name, the thumbnail display function displays contracted data including plural image data to improve visibility and to allow easy selection of the desired data. In the present embodiment, the image pickup data shot by the CCD camera 20 will be used as an example of the data to be displayed using the thumbnail display function. Any other data such as music data and document data may also be employed as well as the combination thereof.

The thumbnail display function serves to switch the data image between a thumbnail image (large thumbnail image) displayed as a fine thumbnail image and a thumbnail image (small thumbnail image) displayed as plural thumbnail images each with inferior quality.

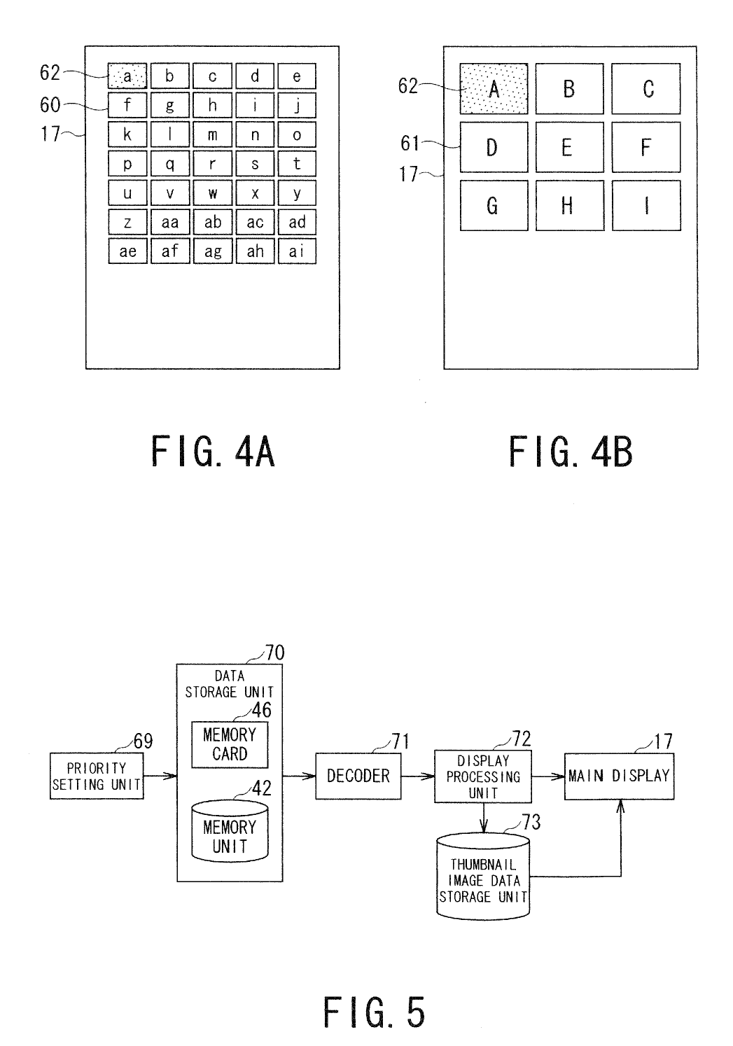

FIG. 4 shows an exemplary thumbnail image displayed on the main display 17 as first and second display units. FIG. 4A shows small thumbnail images 60, and FIG. 4B shows large thumbnail images 61. An uppercase letter or a lowercase letter marked on the package where the thumbnail image is displayed is provided for explaining the displayed position of the thumbnail image.

The state where the thumbnail image is displayed on the main display 17 will be referred to as a thumbnail display mode. A state where the small thumbnail image 60 is displayed will be referred to as a small thumbnail display mode, and a state where the large thumbnail image 61 is displayed will be referred to as a large thumbnail display mode. In the thumbnail display mode, the thumbnail image corresponding to the image pickup data stored in the data storage unit 70 such as the memory unit 42 and the memory card 46 is displayed on the main display 17 based on the predetermined order. The predetermined order is determined based on the order of data arrayed on the data list by various attribute information data added to the image pickup data for forming the thumbnail image, for example, data name, image pickup date, data size, and data type.

The display mode may be switched between the small thumbnail display mode and the large thumbnail display mode by depressing the first soft key 14a or the second soft key 14b for receiving the switching process of the thumbnail display mode. For example, in the small thumbnail display mode, when the predetermined small thumbnail image 60 is selected by the cursor 62 and the first soft key 14a is depressed, the display mode is switched to the large thumbnail display mode. In the large thumbnail display mode, when the predetermined large thumbnail image 61 is selected by the cursor 62 and the second soft key 14b is depressed, the display mode is switched to the small thumbnail display mode. An arbitrary key may be set to receive the switching process of the thumbnail display mode, for example, the soft key 14a may be set to switch the display mode to the small thumbnail display mode from the large thumbnail display mode.

In the thumbnail display mode, the cursor 62 movable in the vertical and lateral directions is used by the user for selecting the desired data. The cursor 62 moves on the thumbnail image in the vertical and lateral directions based on the operation of the arrow key of the operation key 14 as the cursor moving device performed by the user in the vertical and lateral directions.

When the return key of the operation key 14 is depressed, the data selected by the cursor 62 are displayed independently. Referring to FIG. 4, half-tone dotted portions on the small thumbnail image 60 and the large thumbnail image 61, that is, the data corresponding to the position “a” shown in FIG. 4A and the position “A” shown in FIG. 4B are selected by the cursor 62.

In the state where the standby screen or menu screen is displayed, the small thumbnail display mode shown in FIG. 4A is enabled after the control unit 41 receives the command to display the small thumbnail image 60 via the operation key 14. In the small thumbnail display mode, 35 (7×5) thumbnail images arrayed in matrix are displayed on the main display 17.

Upon starting of the small thumbnail display mode, the cursor 62 may select the small thumbnail image 60 (“a” shown in FIG. 4A) at the upper left or the small thumbnail image 60 (“m” shown in FIG. 4A). In the transition from the small thumbnail display mode to the large thumbnail display mode, the cursor 62 is structured to select the large thumbnail image 61 generated from the same image pickup data as the small thumbnail image 60 selected by the cursor 62 in the previous small thumbnail display mode.

The large thumbnail display mode shown in FIG. 4B is started after the control unit 41 receives the command to display the large thumbnail image 61 via the operation key 14 while the standby screen or the menu screen is displayed. Alternatively, the large thumbnail display mode is started after the control unit 41 receives the command to display the large thumbnail image 61 through operation of the specific operation key 14, for example, the first soft key 14a or the second soft key 14b upon starting of the small thumbnail display mode. In the large thumbnail display mode, 9 (3×3) thumbnail images arrayed in matrix are displayed on the main display 17.

The small thumbnail display mode is used for roughly searching the position of the desired data while displaying the small thumbnail images 60 corresponding to the plural data. The large thumbnail display mode is used for displaying the large thumbnail images 61 as fine images each with excellent visibility for the purpose of determining the desired data.

FIG. 5 is a functional block diagram which represents the function as first and second thumbnail image data generation sections for generating the thumbnail image data under the control of the control unit 41 of the cellular phone 1.

The thumbnail image data are generated based on the image pickup data stored in the data storage unit 70 such as the memory unit 42 and the memory card 46. The data storage unit 70 includes various types of data including image data, video data, music data, and document data as well as the image pickup data.

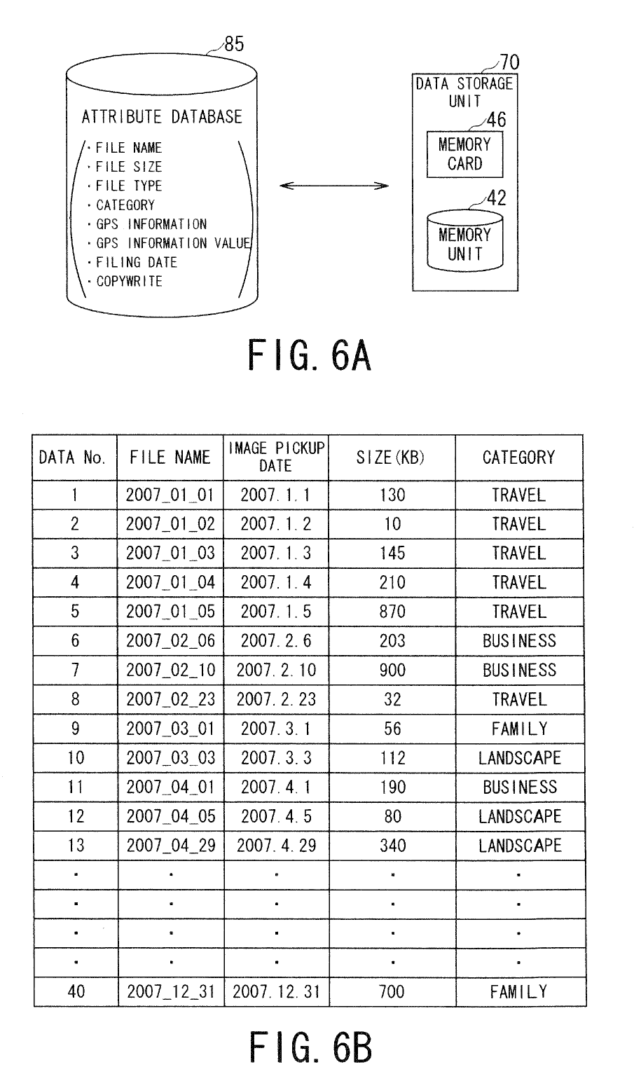

FIG. 6A conceptually shows various types of data stored in the data storage unit 70 such as the memory unit 42 and the memory card 46, and an attribute information database 85. As described above, the data stored in the data storage unit 70 such as the memory unit 42 and the memory card 46 have various attribute information data added thereto, for example, the file name, the file size, the file type, the category arbitrarily added upon data storage, the GPS information, the GPS information value, the filing date, and copy right information.

The memory unit 42 of the cellular phone 1 contains the attribute information database 85 as the data management region to which the attribute information data are added to allow the user to refer to the data list having data arrayed by the attribute information. The attribute information database 85 will be described in more detail hereinafter.

FIG. 6B shows a data list having the image pickup data stored in the data storage unit 70 arrayed in accordance with the image pickup date. The small thumbnail image data are generated in the order of the data number on the data list.

A decoder 71 shown in FIG. 5 is realized by the video codec of the compression/extension processing unit 37, for example, to decode the image pickup data. The decoded image pickup data care output to a display processing unit. The image pickup data may be prioritized by a priority setting unit 69 realized by the control unit 41 as exemplary image pickup data output from the decoder 71. The priority setting unit 69 is structured to prioritize the image pickup data output to the decoder 71 in accordance with the small thumbnail image 60 selected by the cursor 62 to be described below.

The display processing unit 72 subjects the decoded image pickup data to the conversion process into a desired size so as to generate the thumbnail image data. For example, the image pickup data are converted into the size which allows the small thumbnail images 60 in matrix of (7×5) to be arrayed and displayed on the main display 17. Meanwhile, the image pickup data are converted into the size which allows the large thumbnail images 61 in matrix of (3×3) to be arrayed and displayed on the main display 17.

The generated thumbnail image data are sequentially displayed on the main display 17 or stored in a thumbnail image data storage unit 73. The thumbnail image data storage unit 73 is formed as a cache memory serving as a second thumbnail image data storage unit for temporarily storing the preliminarily generated thumbnail image data. In the embodiment, the preliminarily generated large thumbnail image data are stored in the small thumbnail display mode. The thumbnail image based on the thumbnail image data stored in the thumbnail image data storage unit 73 are displayed on the main display 17 at a predetermined timing under the control of the control unit 41.

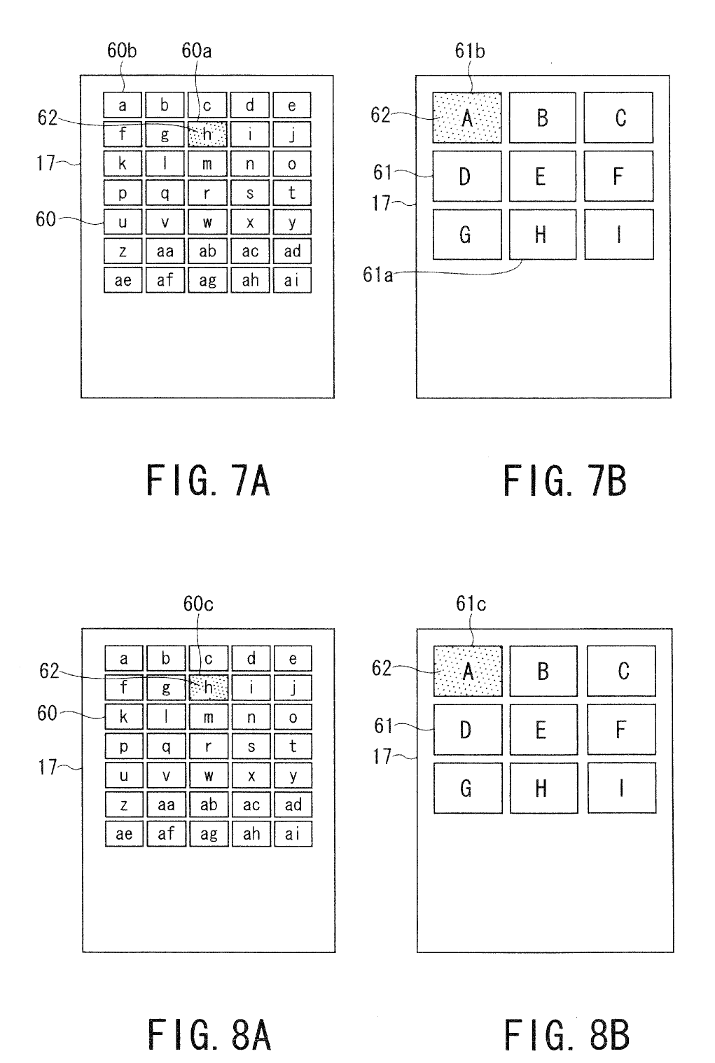

FIG. 7 shows a first example of the thumbnail display mode switching process from the small thumbnail display mode to the large thumbnail display mode. FIG. 7A shows the small thumbnail display mode, and FIG. 7B shows the large thumbnail display mode.

Upon starting of the small thumbnail display mode shown in FIG. 7A, the image pickup data stored in the data storage unit 70 such as memory unit 42 and memory card 46 are formed into, for example, 35 small thumbnail image data sequentially based on the predetermined order, for example, the data number of the image pickup data shown in FIG. 6B which are listed in the order of the image pickup date.

The small thumbnail images 60 based on the generated small thumbnail image data are displayed on the main display 17 in the order of generation. The display position of the small thumbnail image 60 is sequentially determined from the upper left section of the screen on the main display 17. For example, the small thumbnail image 60 generated based on the image pickup data with data number 1 is displayed on the position “a” shown in FIG. 7A. The small thumbnail image 60 generated based on the image pickup data with data number 2 is displayed on the position “b”, and the small thumbnail image 60 generated based on the image pickup data with data number 3 is displayed on the position “c”.

The cursor 62 is constructed to select the arbitrary small thumbnail image 60 based on the input through the operation key 14 by the user. FIG. 7A shows that the cursor 62 selects the small thumbnail image 60a on a position “h” generated based on the image pickup data with data number 8.

The large thumbnail display mode shown in FIG. 7B is started under the control of the control unit 41 upon switching from the small thumbnail display mode shown in FIG. 7A to the large thumbnail display mode shown in FIG. 7B in response to depression of the first soft key 14a. For example, 9 large thumbnail image data are sequentially generated based on the order of the data number on the data list shown in FIG. 6B. That is, the large thumbnail image data are generated based on the image pickup data from data numbers 1 to 9 on the data list shown in FIG. 6B.

The large thumbnail image 61 based on the generated large thumbnail image data are displayed on the main display 17 sequentially in the order of generation. The display position of the large thumbnail image 61 is sequentially determined to the section from the upper left section of the screen on the main display 17. For example, the large thumbnail image 61 generated based on the image pickup data with data number 1 is displayed on the position “A” shown in FIG. 7B, the large thumbnail image 61 generated based on the image pickup data with data number 2 is displayed on the position “B” shown in FIG. 7B, and the large thumbnail image 61 generated based on the image pickup data with data number 3 is displayed on the position “C” shown in FIG. 7B.

The image pickup data with data number 8 for forming the small thumbnail image 60a selected by the cursor 62 in the small thumbnail display mode shown in FIG. 7A will be displayed as the eighth generated large thumbnail image 61a in the large thumbnail display mode at a position “H” as shown in FIG. 7B. Immediately after starting the large thumbnail display mode, the cursor 62 selects the large thumbnail image 61b based on the image pickup data with data number 1 on a position “A”.

FIG. 8 shows a second example of the thumbnail display mode switching process from the small thumbnail display mode to the large thumbnail display mode. FIG. 8A shows the small thumbnail display mode, and FIG. 8B shows the large thumbnail display mode.

The process in the small thumbnail display mode and the process performed upon starting of the small thumbnail display mode shown in FIG. 8A are substantially the same those shown in FIG. 7A, and explanations thereof will be hence omitted herein.

The large thumbnail display mode shown in FIG. 8B is started under the control of the control unit 41 in the small thumbnail display mode shown in FIG. 8A when performing the mode switching process to the large thumbnail display mode shown in FIG. 8B in response to depression of the predetermined operation key 14, for example, the first soft key 14a.

The large thumbnail image data, for example, 9 large thumbnail image data are generated in the order of the data number based on the image pickup data with data number 8 for forming the small thumbnail image 60c selected by the cursor 62 in the small thumbnail display mode based on the data number on the data list shown in FIG. 6B, and the image pickup data with the data number subsequent to 8. In other words, the large thumbnail image data are generated based on the image pickup data with the data numbers from 8 to 16 on the data list shown in FIG. 6B.

The large thumbnail images 61 based on the generated large thumbnail image data are displayed on the main display 17 sequentially in the order of generation. The large thumbnail images 61 are determined to be positioned from the upper left section of the main display 17 in the ascending order of the data number. For example, the large thumbnail image 61 generated based on the image pickup data with the data number 8 is displayed on the position “A” shown in FIG. 8B, the large thumbnail image 61 generated based on the image pickup data with the data number 9 is displayed on the position “B”, and the large thumbnail image 61 generated based on the image pickup data with the data number 10 is displayed on the position “C”.

The image pickup data with the data number 8 selected by the cursor 62 for forming the small thumbnail image 60c in the small thumbnail display mode shown in FIG. 8A are displayed on the position “A” corresponding to the firstly generated large thumbnail image 61c in the large thumbnail display mode shown in FIG. 8B. Immediately after starting the large thumbnail display mode, the cursor 62 selects the large thumbnail image 61c based on the image pickup data with the data number 8 on the position “A” for forming the small thumbnail image 60c which has been selected by the cursor 62 in the small thumbnail display mode.

Upon starting of the small thumbnail display mode, the thumbnail display function allows the user to predict subsequent switching of the display mode to the large thumbnail display mode. In the switching process of the display mode from the small thumbnail display mode to the large thumbnail display mode referring to the first and the second examples, the large thumbnail image data are expected to be generated after switching of the display mode from the small thumbnail display mode to the large thumbnail display mode. The resultant display speed of the large thumbnail image 61 after the switching operation is lowered, thus failing to perform efficient switching operation.

The mode switching function for switching the thumbnail display mode is expected to be used by the user for roughly searching the desired data in the small thumbnail display mode, and for determining the desired data while confirming the fine large thumbnail image 61 in the switched large thumbnail display mode. The user operates the operation key 14 to move the cursor 62 to the point where the desired data apparently exist in the small thumbnail display mode. Then, the display mode is switched to the large thumbnail display mode to display the large thumbnail image 61 as the fine thumbnail around the cursor 62, thus allowing the user to select the data.

In the first example, upon switching of the display mode from the small thumbnail display mode to the large thumbnail display mode, the data with the data number 1 will be displayed on the position “A” irrespective of the position selected by the cursor 62 in the small thumbnail display mode, thus failing to perform efficient mode switching operation.

In the second example, the large thumbnail image data are generated based on the image pickup data for forming the small thumbnail image 60c selected by the cursor 62 in the small thumbnail display mode, and are displayed as the large thumbnail images 61c on the position “A”. The subsequent large thumbnail images 61 of the large thumbnail image data generated based on the image pickup data with the subsequent data numbers will be displayed on the respective positions of “B”, “C”, and the like. The resultant switching operation is more efficient compared with the first example.

In the second example, the data with the data number smaller than that of the image pickup data selected by the cursor 62 (for example, the image pickup data for forming the small thumbnail image 60 displayed on “f” or “g” shown in FIG. 8A) in the small thumbnail display mode just before the mode switching are not displayed immediately after the mode switching to the large thumbnail display mode. Accordingly, the mode switching is not performed with sufficient efficiency.

The cellular phone 1 to be described in the following third example preliminarily generates the large thumbnail image data which are prioritized in accordance with the position selected by the cursor 62 upon starting of the small thumbnail display mode. Upon starting of the large thumbnail display mode, the large thumbnail image 61 will be efficiently displayed in the order of the higher priority.

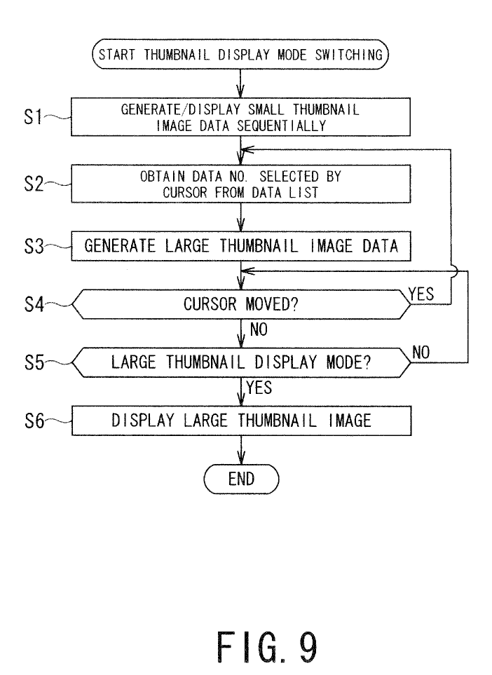

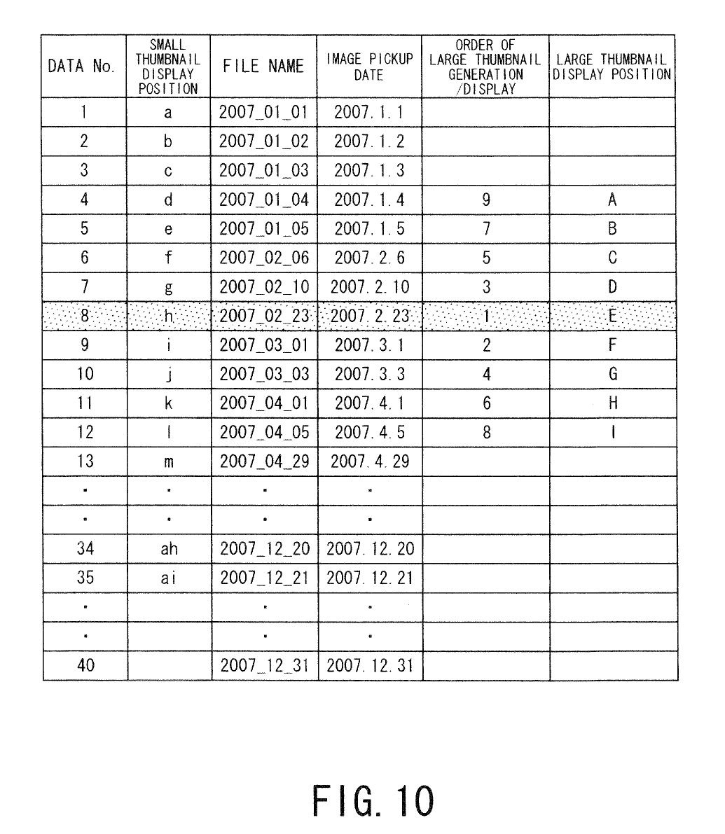

Referring to FIG. 9, the thumbnail display mode switching process performed in the cellular phone 1 according to the embodiment will be described as the third example. The thumbnail display mode switching process is performed upon reception of the command to start the small thumbnail display mode by the control unit 41 through the operation key 14. FIG. 10 partially shows a data list having the image pickup data stored in the data storage unit 70 shown in FIG. 6B arrayed in accordance with the image pickup date. The list further includes columns of the small thumbnail display position, the large thumbnail generation/display order, and the large thumbnail display position for the purpose of explaining the third example.

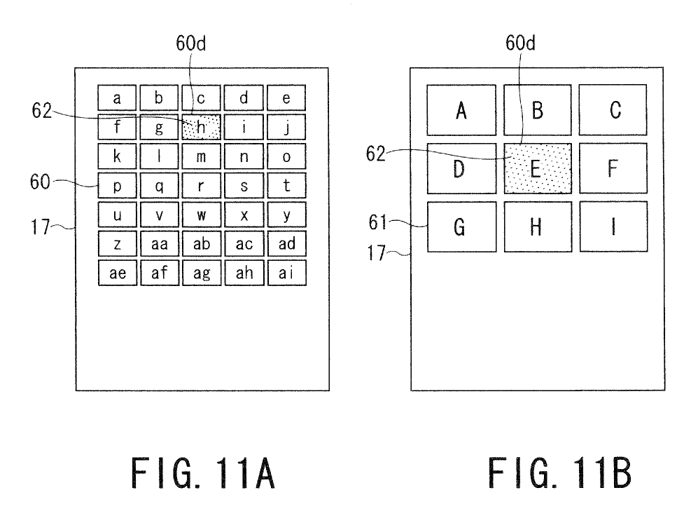

FIG. 11 shows the thumbnail display mode switching process as the third example from the small thumbnail display mode to the large thumbnail display mode performed in the cellular phone 1 in the present embodiment. FIG. 11A shows the small thumbnail display mode, and FIG. 11B shows the large thumbnail display mode. The operation will be explained hereunder with reference to the flowchart of FIG. 9.

In step S1 shown in FIG. 9, the control unit 41 refers to the data list shown in FIG. 10 to generate predetermined numbers of the small thumbnail image data from the image pickup data with the data number 1 at the head. In the embodiment, 35 small thumbnail image data with the data numbers from 1 to 35 are generated.

The control unit 41 sequentially displays the small thumbnail images 60 based on the generated small thumbnail image data at predetermined positions on the main display 17. For example, as shown by the column of the small thumbnail display position of the list shown in FIG. 10, the small thumbnail data corresponding to the image pickup data with the data numbers from 1 to 35 are sequentially displayed on positions “a”, “b”, . . . “ah” and “ai”, respectively. Upon starting of the small thumbnail display mode, when the operation key 14 is operated to scroll the screen for displaying the small thumbnail image 60 which is not displayed on the screen, the control unit 41 refers to the data list to generate the small thumbnail image data based on the image pickup data with the subsequent data number for forming the small thumbnail image 60 displayed on the position “a”.

The control unit 41 generates the small thumbnail image data by outputting various data stored in the data storage unit 70 such as the memory unit 42 and the memory card 46 to the decoder 71 and the display processing unit 72.

At this time, the cursor 62 is displayed on the small thumbnail image 60, which moves in the vertical and lateral directions accompanied with the operation of the arrow key of the operation key 14 in the vertical and lateral directions.

In step S2 of FIG. 9, the priority setting unit 69 obtains the data number of the small thumbnail image 60 selected by the cursor 62 from the data list shown in FIG. 10. In the embodiment, the priority setting unit 69 obtains the data number 8 of the small thumbnail image 60d positioned on “h” selected by the cursor 62 in the small thumbnail display mode shown in FIG. 11A.

In step S3, the control unit 41 preliminarily generates predetermined numbers of large thumbnail image data to be displayed in the large thumbnail display mode upon starting of the small thumbnail display mode. In the embodiment, 9 large thumbnail image data are preliminarily generated. The large thumbnail image data are generated by outputting the image pickup data sequentially to the decoder 71 for decoding, and the display processing unit 72 for converting the decoded data into those with a predetermined size. The generated large thumbnail image data are temporarily stored in the thumbnail image data storage unit 73.

The image pickup data for forming the large thumbnail image data are generated based on the image pickup data prioritized by the priority setting unit 69 in accordance with the image pickup data for forming the small thumbnail image 60 selected by the cursor 62 in the small thumbnail display mode. The priority setting unit 69 prioritizes the image pickup data such that the priority of the data with the adjacent data number becomes higher for the purpose of generating and outputting the data in the posterior order (data with large data number) and the data in the anterior order (data with small data number) alternately in accordance with the data number on the data list shown in FIG. 10. The column of the large thumbnail generation/display order of the data list of FIG. 10 represents the order of generating/displaying the prioritized large thumbnail image data. The large thumbnail image data are generated in the order of the data numbers from 8, 9, 7, 10, 6, 11, 5, 12, and 4 sequentially.

Corresponding to the small thumbnail images 60 displayed in the small thumbnail display mode shown in FIG. 11A, the large thumbnail image data are generated in the predetermined order from the image pickup data for forming the small thumbnail images 60 positioned on “d” to “l”.

In step S4, the control unit 41 determines whether or not the operation for moving the cursor 62 has been received. When it is determined that the operation for moving the cursor 62 has been received via the operation key 14, the process returns to data number obtaining step S2 where the priority setting unit 69 obtains the data number of the image pickup data for forming the small thumbnail image 60 selected by the cursor 62 from the data list shown in FIG. 10. Subsequently, the process proceeds to large thumbnail image data generation step S3 and further to the cursor movement determination step S4.

Meanwhile, when it is judged that the operation for moving the cursor 62 has not been received, the control unit 41 determines whether or not the mode switching from the small thumbnail display mode to the large thumbnail display mode has been performed in step S5. If it is judged that the switching process to the large thumbnail display mode has not been performed, the process returns to the cursor movement determination step S4.

Meanwhile, when it is judged that the command for switching the display mode to the large thumbnail display mode has been received, the control unit 41 displays the large thumbnail images 61 based on the preliminarily generated large thumbnail image data stored in the thumbnail image data storage unit 73 on the main display 17 in step S6. The large thumbnail images 61 are displayed in the same generation order based on the priority set by the priority setting unit 69. In other words, the large thumbnail image 61 is displayed based on the order shown in the column of the large thumbnail generation/display order on the data list shown in FIG. 10.

The cursor 62 is displayed while selecting the large thumbnail image 61d generated from the same image pickup data as those for the small thumbnail image 60d which have been selected by the cursor 62 in the small thumbnail display mode.

The control unit 41 displays the large thumbnail image 61d formed from the image pickup data with the data number 8 for forming the small thumbnail image 60d which have been selected by the cursor 62 in the small thumbnail display mode shown in FIG. 11B so as to become substantially the center of the array of the large thumbnail images 61. For example, the large thumbnail image 61d is displayed on a position “E” shown in FIG. 11B.

The control unit 41 displays the large thumbnail images 61 in the order of the position adjacent to the point “E” based on the order shown in the column of the large thumbnail generation/display order on the data list shown in FIG. 10. The large thumbnail images 61 are displayed at the positions indicated by the column of the large thumbnail display position shown in FIG. 10. That is, the large thumbnail images 61 are sequentially displayed from the upper left portion of the screen on the main display 17 in the ascending order with respect to the data number of the image pickup data. For example, the large thumbnail image 61 generated based on the image pickup data with the data number 4 is displayed on the position “A” shown in FIG. 11B. The large thumbnail image 61 generated based on the image pickup data with the data number 5 is displayed on the position “B”. The large thumbnail image 61 generated based on the image pickup data with the data number 6 is displayed on the position “C”.

The aforementioned thumbnail image display switching process ends.

Upon reception of the operation for moving the cursor 62, or the display mode switching to the large thumbnail display mode before completion of generation of 9 large thumbnail image data in large thumbnail image data generation step S3, the control unit 41 stops generation of the large thumbnail image data in step S3. Upon reception of the operation for moving the cursor 62, the control unit 41 controls such that “YES” is obtained in the cursor movement determination step S4, and proceeds the process to the data number obtaining step S2. Upon reception of the display mode switching to the large thumbnail display mode, the control unit 41 controls such that “YES” is obtained in the display mode determination step S5 to keep generation of the large thumbnail image data in the large thumbnail image data generation step S3 after transition to the large thumbnail display mode. The control unit 41 further controls to display the large thumbnail image in the large thumbnail display step S6.

With the use of the cellular phone 1, the large thumbnail image data are generated upon starting of the small thumbnail display mode on the assumption that the display mode is switched to the large thumbnail display mode upon starting of the large thumbnail display mode such that the large thumbnail image 61 is efficiently displayed upon transition to the large thumbnail display mode.

Immediately after switching of the display mode from the small thumbnail display mode to the large thumbnail display mode, the large thumbnail image 61, which is generated from data arrayed adjacent to those displayed as the small thumbnail image 60 selected by the cursor 62 in the small thumbnail display mode, is displayed. The data with a high probability to have the desired data are displayed to allow easy selection of the desired data.

The cellular phone 1 allows the user to efficiently select the desired data using the thumbnail display mode, resulting in improved usability of the thumbnail display function and efficiency for the user to select the image.

The order of generating the large thumbnail image 61 in the small thumbnail display mode, and display order/array upon switching of the display mode to the large thumbnail display mode have been explained as an example. However, any other order and array may be employed.

Both the small and the large thumbnail image data are generated through the decoder 71 and the display processing unit 72, respectively. The thumbnail image data applicable to the small and the large thumbnail image data may be preliminarily generated for forming the small thumbnail image data. Specifically, when the data for forming the small thumbnail image data are decoded by the decoder 71 and then converted into the predetermined size by the display processing unit 72, the data are further converted into the size so as to be used as the large thumbnail image 61. The converted data are then stored in the thumbnail image data storage unit 73. The data may be contracted to be displayed as the small thumbnail image 60 on the main display 17. The data stored in thumbnail image data storage unit 73 may be displayed as the large thumbnail image 61 without being subjected to the size conversion. This makes it possible to efficiently generating the large thumbnail image data 61 in the large thumbnail display mode.

Hereunder, another process for improving usability of the cellular phone 1 for selecting the desired data upon switching of the display mode from the small thumbnail display mode to the large thumbnail display mode will be described.

The process is executed to prioritize the large thumbnail image 61 displayed upon switching of the display mode from the small thumbnail display mode to the large thumbnail display mode based on the attribute information added to the image pickup data for forming the small thumbnail image 60 selected by the cursor 62 in the small thumbnail display node. This makes it possible to allow the user to efficiently select the desired data displayed upon starting of the large thumbnail display mode with predictability to a certain level.

As described above, each of the respective data stored in the data storage unit 70 such as the memory unit 42 or the memory card 46 as shown in FIG. 6 is provided with various types of attribute information data, for example, file name, file size, file type, category arbitrarily added upon data storage, presence/absence of GPS information, GPS information value, filing date, and presence/absence of copyright.

The memory unit 42 of the cellular phone 1 contains the attribute information database 85 as the data management region for the data to which those attribute information data are added so as to allow the user to refer to the data list having data arrayed by the attribute information. The attribute information database 85 contains the data list having data arrayed in the order of Japanese syllabary based on the file name, the data list having data arrayed with the same file type, and the data list having data arrayed in the order of the file size.

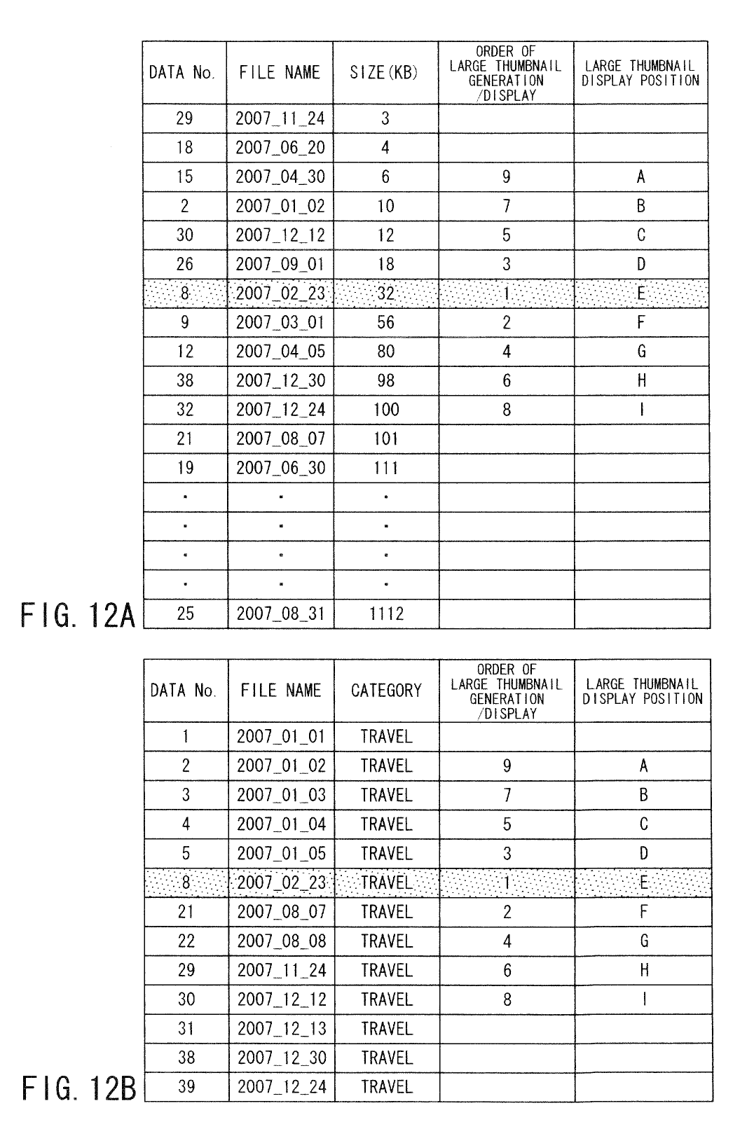

FIG. 12 shows exemplary data lists having data stored in the data storage unit 70 shown in FIG. 6B listed by the attribute information and stored in the attribute information database 85. FIG. 12A partially shows the data list having data arrayed in the order of the file size of the image pickup data as one of the attribute information data. FIG. 1213 partially shows the data list having data arrayed based on the category arbitrarily added upon storage of the image pickup data. The user is allowed to arbitrarily add the category based on the type of the image pickup data, for example, travel, business, family, landscape and the like. Referring to FIG. 12B, the image pickup data categorized as “travel” are arrayed on the data list.

The various types of data lists stored in the attribute information database 85 are correlated with the image pickup data stored in the data storage unit 70. Arbitrary image pickup data may be read with reference to the data list as occasion demands.

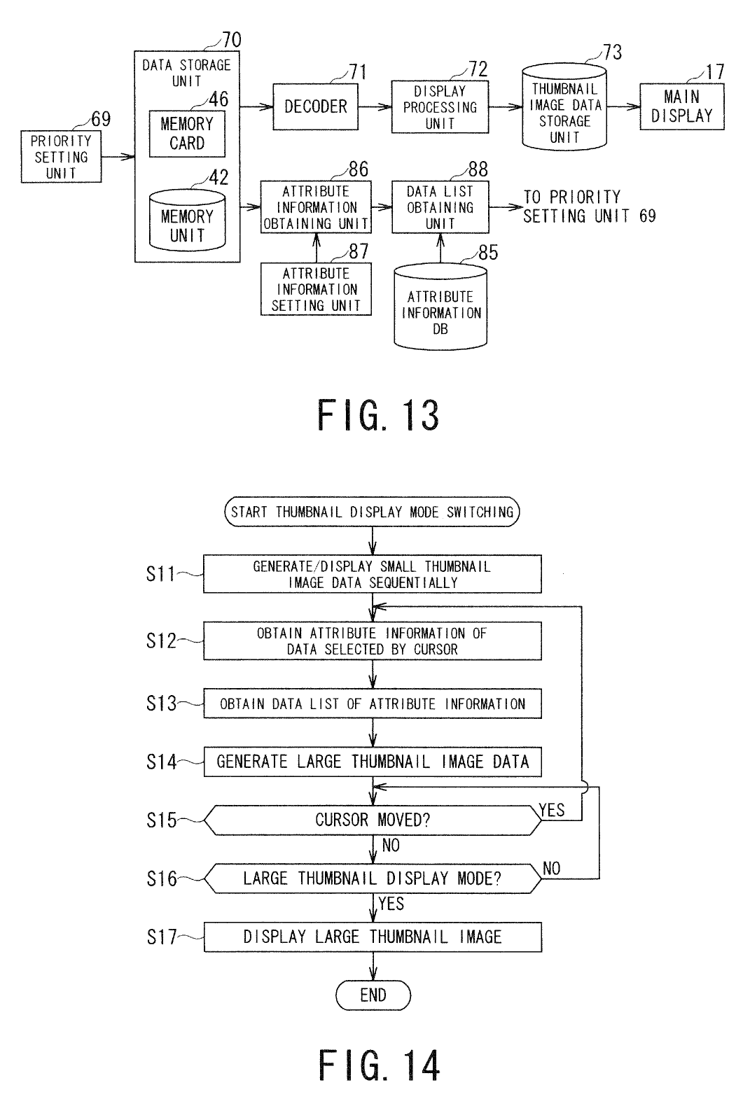

FIG. 13 is a functional block diagram especially showing the function as first and second thumbnail image data generation sections for preliminarily generating the large thumbnail image data upon starting of the small thumbnail display mode under the control of the control unit 41 in the cellular phone 1. Explanations with respect to each generation/display process of the small thumbnail image data in the small thumbnail display mode and the large thumbnail image data in the large thumbnail display mode are substantially the same as the process explained referring to FIG. 5, and hence, the explanations thereof will be omitted herein.

The attribute information obtaining unit 86 obtains the image pickup data for forming the small thumbnail image 60 selected by the cursor 62 in the small thumbnail display mode from the data storage unit 70 to obtain the attribute information of the obtained data. The obtained attribute information data have been preliminarily set by the attribute information setting unit 87.

The attribute information setting unit 87 sets the attribute information of the data to be displayed with priority after starting the large thumbnail display mode. The aforementioned attribute information may be preliminarily set through the operation key 14 to set the arbitrary attribute information added to the image pickup data which allow the large thumbnail image 61 to be displayed with priority. The attribute information includes, for example, the image pickup date, category, the file size and the file name.

The data list obtaining unit 88 obtains the data list having data arrayed based on the attribute information obtained in the attribute information obtaining unit 86 from the attribute information database (DB) 85. When the attribute information of the data to be displayed with priority is set to the “category” in the attribute information setting unit 87, the attribute information obtaining unit 86 obtains the data list of the image pickup data to which the category obtained thereby is added as shown in FIG. 12B so as to be output to a priority setting unit 69.

The priority setting unit 69 prioritizes the image pickup data based on the array order of the data list. For example, when the data output from the attribute information obtaining unit 86 correspond to the half-tone dot meshed image pickup data with data number 8 on the data list shown in FIG. 12B, the priority setting unit 69 prioritizes 9 image pickup data such that the priority of the data with the data number 8 becomes the highest to be prioritized from the numbers 8, 21, 5, 22, 4, 29, 3, 30, and 2.

The decoder 71 decodes the image pickup data output from the data storage unit 70 and prioritized by the priority setting unit 69.

Operations of the display processing unit 72 and the thumbnail image data storage unit 73 are substantially the same as those of the display processing unit 72 and the thumbnail image data storage unit 73 shown in FIG. 5, and hence, the explanations thereof will be omitted herein.

FIG. 14 is a flowchart showing another thumbnail display switching process executed in the cellular phone 1 according to the present embodiment. In the embodiment, the image pickup data picked up by the CCD camera 20 are employed as data displayed in the thumbnail display mode.

The small thumbnail image generation/display step S11 is substantially the same as the small thumbnail image generation/display step S1 of FIG. 9, and explanation thereof will be hence omitted herein.

In step S12, the attribute information obtaining unit 86 obtains the attribute information added to the image pickup data for forming the small thumbnail image 60 selected by the cursor 62. The obtained attribute information is preliminarily set by the attribute information setting unit 87. For example, if the attribute information set by the attribute information setting unit 87 represents the category, the category added to the image pickup data, for example, “travel” may be obtained.

In step S13, the data list obtaining unit 88 obtains the data list having data arrayed based on the attribute information obtained by the attribute information obtaining unit 86 from the attribute information database (DB). For example, in the case where the attribute information is set to “category”, and the “travel” is set as the category added to the image pickup data, the data list having the image pickup data to which the “travel” is added is obtained as shown in FIG. 12B.

In step S14, the control unit 41 preliminarily generates predetermined numbers of large thumbnail image data to be displayed in the large thumbnail display mode upon starting of the small thumbnail display mode. In the embodiment, 9 large thumbnail image data are generated. The thus generated large thumbnail image data are temporarily stored in the thumbnail image data storage unit 73.

The large thumbnail image data are generated based on the image pickup data prioritized by the priority setting unit 69 in accordance with the small thumbnail image 60 selected by the cursor 62 in the small thumbnail display mode. Based on the array order of the data list obtained in data list obtaining step S13, the priority setting unit 69 sets the adjacent arrayed data to have higher priority such that the data in the posterior arrangement order and the data in the anterior arrangement order are output and generated alternately. The column of the large thumbnail generation/display order on the data list shown in FIG. 12B indicates the generation/display order of the prioritized large thumbnail image data. The large thumbnail image data will be generated in the order of the data with the data numbers from 8, 21, 5, 22, 4, 29, 3, 30, and 2.

In step S15, the control unit 41 determines whether or not the operation for moving the cursor 62 has been received. When it is determined that the operation for moving the cursor 62 has been received via the operation key 14, the control unit 41 returns the process to attribute information obtaining step S12. The attribute information obtaining unit 86 obtains the attribute information added to the image pickup data for forming the small thumbnail image 60 selected by the cursor 62. Thereafter, the process proceeds to data list obtaining step S13, large thumbnail image data generation step S14, and cursor movement determination step S15.

Meanwhile, when it is determined that the operation for moving the cursor 62 has not been received, the control unit 41 proceeds the process to step S16 in which it is determined whether or not the display mode switching from the small thumbnail display mode to the large thumbnail display mode has been performed. When it is determined that the display mode switching to the large thumbnail display mode has not been performed, the control unit 41 returns the process to cursor movement determination step S15.

Meanwhile, when it is determined that a command for switching the display mode to the large thumbnail display mode has been received, the control unit 41 proceeds the process to step S17 in which the large thumbnail image 61 based on the large thumbnail image data preliminarily generated and stored in the thumbnail image data storage unit 73 is displayed on the main display 17. The large thumbnail images 61 are displayed based on the priority set by the priority setting unit 69 in the same generation order. That is, the large thumbnail images 61 are displayed based on the order indicated by the column of the large thumbnail generation/display order on the data list shown in FIG. 12B.

The control unit 41 displays the large thumbnail image 61d generated from the image pickup data with data number 8 for forming the small thumbnail image 60d selected by the cursor 62 in the small thumbnail display mode shown in FIG. 11B so as to take substantially the center of the array of the large thumbnail images 61. For example, the large thumbnail image 61d is displayed on a position “E” as shown in FIG. 11B.

The control unit 41 displays the large thumbnail images 61 in the order of the position adjacent to the “E” position based on the order indicated by the large thumbnail generation/display order column on the data list shown in FIG. 10. The large thumbnail images 61 are displayed at the positions corresponding to those indicated by the large thumbnail display position column shown in FIG. 12B. That is, the large thumbnail images 61 are displayed from the upper left section of the screen sequentially on the main display 17 based on the array order on the data list shown in FIG. 12B. For example, the large thumbnail image 61 generated based on the image pickup data with data number 2 is displayed on the position “A” shown in FIG. 11B. The large thumbnail image 61 generated based on the image pickup data with data number 3 is displayed on the position “B”. The large thumbnail image generated based on the image pickup data with data number 4 is displayed on the position “C”. Then, the thumbnail display switching process ends.

In the cellular phone 1, when the desired data are selected by the cursor 62 in the small thumbnail display mode, the large thumbnail image data of the data with the corresponding attribute information are preliminarily generated. Accordingly, the large thumbnail image 61 displayed upon the display mode switching to the large thumbnail display mode is likely to be located with predictability, thus further improving usability for selecting the desired data. The thumbnail display mode switching process is effective for the user to select the desired data from the data with common attribute information.

The large thumbnail images 61 displayed after the process for switching the display mode to the large thumbnail display mode may be arbitrarily prioritized based on the attribute information. This makes it possible to improve usability of the cellular phone 1 for the user.

The present invention is applicable not only to the cellular phone 1 but also the mobile terminal devices for PDA (Personal Digital Assistant), personal computer, portable game machine, portable music player, portable video player and the like.

The series of processing as described in the embodiment may be executed by the software. However, hardware may be employed to execute the aforementioned process.

In the embodiment of the present invention, steps of the flowchart are executed in time series with the aforementioned order. They do not have to be executed in time series but may be executed in simultaneously or independently.

What is claimed is:

1. A mobile terminal device comprising:
a data storage unit configured to store data;
a first generation unit configured to generate a first thumbnail image data based on the data output from the data storage unit;
a first display unit configured to display a plurality of first thumbnail images corresponding to a plurality of the first thumbnail image data generated by the first generation unit;
a cursor moving unit configured to move a cursor which selects one of a plurality of the first thumbnail images displayed by the first display unit;
a priority setting unit configured to set a priority with respect to the data stored in the data storage unit in accordance with the first thumbnail image selected by the cursor moved by the cursor moving unit;
a second generation unit configured to generate second thumbnail image data each having a different size from that of the first thumbnail image data based on the data having the priority set by the priority setting unit;
a second thumbnail image data storage unit configured to store the plurality of the second thumbnail image data generated by the second generation unit;
a receiver unit configured to receive a command to display the second thumbnail image corresponding to the second thumbnail image data; and
a second display unit configured to display the plurality of the second thumbnail images stored in the second thumbnail image data storage unit sequentially in a predetermined array from the second thumbnail image corresponding to the second thumbnail image data formed from the data in an order of the priority upon reception of a command to display the second thumbnail images by the receiver unit.

2. The mobile terminal device according to claim 1, wherein each size of the second thumbnail image data is larger than each size of the first thumbnail image data.

3. The mobile terminal device according to claim 1, wherein when the second thumbnail display mode is started, the cursor is displayed to select the second thumbnail image corresponding to the second thumbnail image data generated from the same data as those of the first thumbnail image selected by the cursor when starting the first thumbnail display mode.

4. The mobile terminal device according to claim 1, wherein the data storage unit stores the data and a data list having data for forming the first thumbnail image data arrayed with data numbers in an order of data generation, and the priority setting unit sets the priority in an order of the data number of the data adjacent to that of the data for forming the first thumbnail image selected by the cursor.

5. The mobile terminal device according to claim 4, wherein the plurality of the second thumbnail images displayed by the second display unit are in the predetermined array such that the second thumbnail image corresponding to the second thumbnail image data formed from the data with a small data number among those generated by the second generation unit is displayed to a head of the array sequentially in an order of the data number.

6. The mobile terminal device according to claim 1, wherein an attribute information is added to the data stored in the data storage unit, and the priority setting unit sets a priority with respect to the data based on the attribute information of the data for forming the first thumbnail image selected by the cursor.

7. A mobile terminal device comprising:
a display mode switching unit configured to switch from a first thumbnail display mode for displaying a plurality of first thumbnail images each with a predetermined size to a second thumbnail display mode for displaying a plurality of second thumbnail images each having a size larger than that of the first thumbnail images when starting of the first thumbnail display mode;
a data storage unit configured to store data;
a first generation unit configured to generate the first thumbnail image data based on the data output from the data storage unit when starting the first thumbnail display mode;
a first display unit configured to display the first thumbnail image corresponding to the plurality of the first thumbnail image data generated by the first generation unit;
a cursor moving unit configured to move a cursor to select one of the plurality of the first thumbnail images displayed by the first display unit;
a priority setting unit configured to set a priority with respect to the data stored in the data storage unit in accordance with the first thumbnail image selected by the cursor moved by the cursor moving unit;
a second generation unit configured to generate the second thumbnail image data of the second thumbnail image to be displayed when the second thumbnail display mode is started by the display mode switching unit based on the data having the priority set by the priority setting unit;
a second thumbnail image data storage unit configured to store the second thumbnail image data generated by the second generation unit; and
a second display unit configured to display the second thumbnail images corresponding to the plurality of the second thumbnail image data stored in the second thumbnail image data storage unit sequentially in a predetermined array from the second thumbnail image corresponding to the second thumbnail image data formed from the data in an order of the priority thereof after starting the second thumbnail display mode by the display mode switching unit.

8. The mobile terminal device according to claim 7, wherein when the second thumbnail display mode is started, the cursor is displayed to select the second thumbnail image corresponding to the second thumbnail image data generated from the same data as those of the first thumbnail image selected by the cursor when starting the first thumbnail display mode.

9. The mobile terminal device according to claim 7, wherein the data storage unit stores the data and a data list having data for forming the first thumbnail image data arrayed with data numbers in an order of data generation, and the priority setting unit sets the priority in an order of the data number of the data adjacent to that of the data for forming the first thumbnail image selected by the cursor.

10. The mobile terminal device according to claim 9, wherein the plurality of the second thumbnail images displayed by the second display unit are in the predetermined array such that the second thumbnail image corresponding to the second thumbnail image data formed from the data with a small data number among those generated by the second generation unit is displayed to a head of the array sequentially in an order of the data number.

11. The mobile terminal device according to claim 7, wherein an attribute information is added to the data stored in the data storage unit, and the priority setting unit sets a priority with respect to the data based on the attribute information of the data for forming the first thumbnail image selected by the cursor.

12. A mobile terminal device comprising:
a data storage unit configured to store a plurality of data;
a display unit configured to display an image corresponding to the data stored in the data storage unit;
a first operation unit configured to receive a switching operation between a first thumbnail display mode and a second thumbnail display mode, the first thumbnail display mode being for generating first thumbnail image data based on a plurality of the data stored in the data storage unit to display images corresponding to the plurality of the first thumbnail image data in a predetermined order, and the second thumbnail display mode being for displaying images corresponding to the second thumbnail image data each having a display size larger than that of the first thumbnail image data;
a second operation unit configured to select one of displayed images corresponding to the plurality of the first thumbnail image data when the first thumbnail display mode is set;
a generation unit configured to generate the second thumbnail image data based on selection data correlated with the first thumbnail image selected by the second operation unit from those corresponding to the plurality of the first thumbnail image data, and data correlated with predetermined numbers of images arrayed in an order adjacent to the selected first thumbnail image in the predetermined order when the first thumbnail display mode is set; and
a control unit configured to display the second thumbnail image data generated by the generation unit sequentially from the selected data on the display unit when receiving a switching operation from the currently activated first thumbnail display mode to the second thumbnail image data through the first operation unit.
